(19) United States
(12) Patent Application Publication
(10) Pub. No.: US 2013/0201095 A1
(43) Pub. Date: Aug. 8, 2013

(54) PRESENTATION TECHNIQUES

(71) Applicants: Paul Henry Dietz, Redmond, WA (US); Vivek Pradeep, Bellevue, WA (US); Stephen G. Latta, Seattle, WA (US); Kenneth P. Hinckley, Redmond, WA (US); Hrvoje Benko, Seattle, WA (US); Alice Jane Bernheim Brush, Bellevue, WA (US)

(72) Inventors: Paul Henry Dietz, Redmond, WA (US); Vivek Pradeep, Bellevue, WA (US); Stephen G. Latta, Seattle, WA (US); Kenneth P. Hinckley, Redmond, WA (US); Hrvoje Benko, Seattle, WA (US); Alice Jane Bernheim Brush, Bellevue, WA (US)

(73) Assignee: MICROSOFT CORPORATION, Redmond, WA (US)

(21) Appl. No.: 13/368,062

(22) Filed: Feb. 7, 2012

(51) Int. Cl. G06F 3/01; G09G 5/00

(52) U.S. Cl. 345/156; 715/730

(57) ABSTRACT

Techniques involving presentations are described. In one or more implementations, a user interface is output by a computing device that includes a slide of a presentation, the slide having an object that is output for display in three dimensions. Responsive to receipt of one or more inputs by the computing device, how the object in the slide is output for display in the three dimensions is altered.

### BACKGROUND

Conventional techniques that are utilized to create and output presentations were often static and inflexible. For example, a conventional presentation was often limited to an order in which slides were displayed along with an order in which to display objects within the slides, e.g., text, pictures, and so on. Although a user could navigate backward and forward through the presentation, this navigation was often limited to the output sequence that was specified when the presentation was created.

Consequently, conventional presentations could hamper a user's ability to adjust the presentation during output, such as to respond to different types of viewers of the presentation that may place different amounts of emphasis on information within the presentation. Further, conventional techniques that were utilized to form these presentations could also be inflexible and therefore limit a user to preconfigured slides and animations.

### SUMMARY

Techniques involving presentations are described. In one or more implementations, a user interface is output by a computing device that includes a slide of a presentation, the slide having an object that is output for display in three dimensions. Responsive to receipt of one or more inputs by the computing device, alterations are made as to how the object in the slide is output for display in the three dimensions.

In one or more implementations, a user interface is output by a computing device that is configured to form a presentation having a plurality of slides. Responsive to identification by the computing device of one or more gestures, an animation is defined for inclusion as part of the presentation having one or more characteristics that are defined through the one or more gestures.

In one or more implementations, a presentation is displayed to a plurality of users, the presentation including at least one slide having an object that is viewable in three dimensions by the plurality of users. An input is received that specifies which of the plurality of users are to be given control of the display of the presentation. Responsive to the receipt of the input, one or more gestures are recognized from the user that is to be given control of the display of the presentation and one or more commands are initiated that correspond to the recognized one or more gestures to control the display of the object in the presentation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ presentation techniques described herein.

FIG. 2 is an illustration of a system in an example implementation showing creation of an animation for inclusion in a presentation using one or more gestures.

FIG. 3 is an illustration of a system in an example implementation showing display and manipulation of a 3D object included in a presentation.

FIG. 4 is a flow diagram depicting a procedure in an example implementation in which a presentation is configured to include an animation and output that has a three dimensional object.

FIG. 5 is a flow diagram depicting a procedure in an example implementation in which control of a presentation is passed between users.

FIG. 6 illustrates an example system including various components of an example device that can be implemented as any type of computing device as described with reference to FIGS. 1-3 to implement embodiments of the techniques described herein.

### DETAILED DESCRIPTION

Overview

Conventional techniques that were utilized to create and output presentations were often static and inflexible. Consequently, output of the conventional presentations may support minimal user interaction which may cause the presentation to become repetitive when viewed by an audience. Conventional techniques were also unable to address particular interests of the audience during output, especially if those interests changed during the display of the presentation.

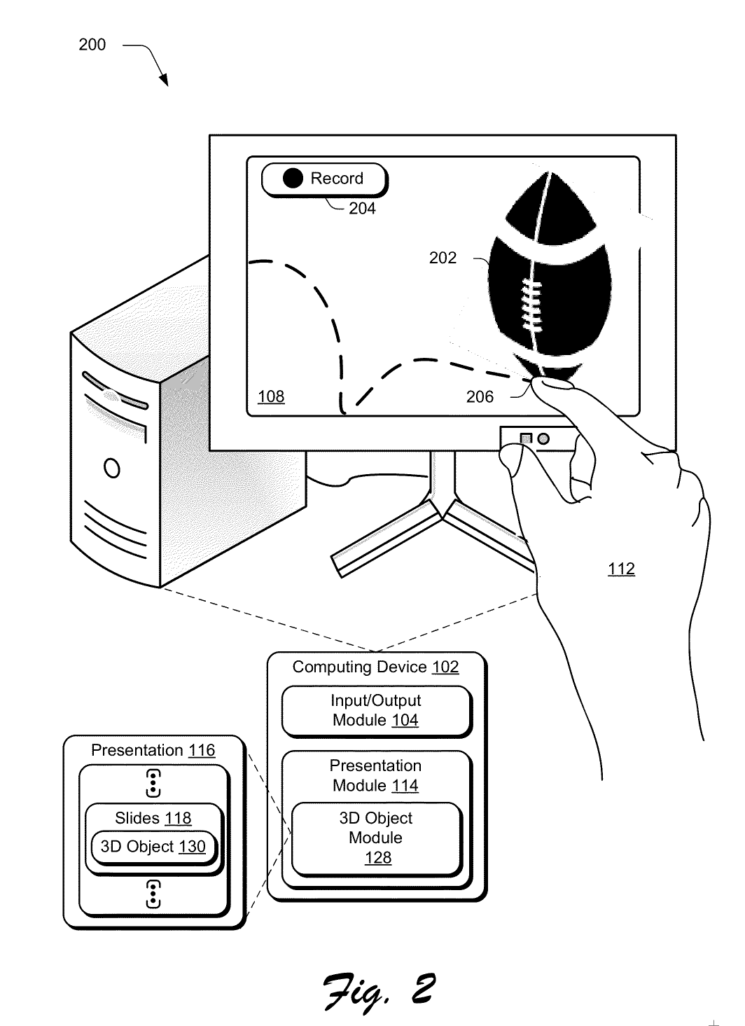

Techniques involving presentations are described. In one or more implementations, techniques are described which may be utilized to create a presentation. For example, the techniques may include functionality to support gestures to define animations that are to be used to display objects in slides of the presentation. This may include resizing the objects (e.g., using a “stretch” or “shrink” gesture), movement of the objects, transitions between the slides, and so on. Thus, in this example a user may utilize gestures to define animations that control how objects and slides are displayed in an intuitive manner, further discussion of which may be found in relation to FIG. 2.

In one or more additional implementations, techniques are described which may be utilized to display and interact with a presentation. The presentation, for instance, may include an object that is displayed in three dimensions to viewers of the presentation, e.g., a target audience. This may include the object output for display as a three-dimensional object in the three dimensions or output for display as a two-dimensional perspective of the three dimensions. The object may be configured to support use of a variety of different user interactions in “how” the object is output as part of the display. This may include rotations, movement, resizing of the object, and so on. Further, these techniques may support functionality to resolve how control of the presentation is to be passed between users. Control of the presentation, for instance, may be passed from a presenter to a member of an audience through recognition of an input from a mobile communications device (e.g., a mobile phone), recognition of a gesture using a camera (e.g., through skeletal mapping and a depth sensing camera), and so forth. In this way, objects in the presentations may support increased flexibility as well as flexibility in who provides the interaction. Further discussion of these and other features may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

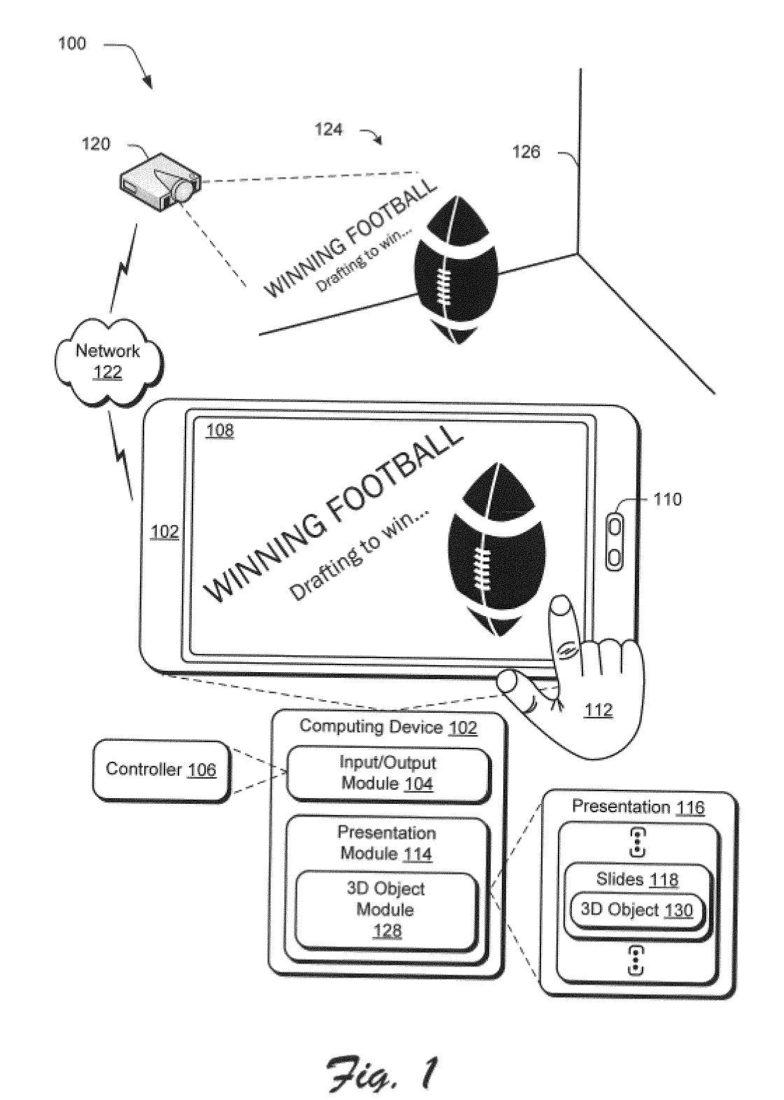

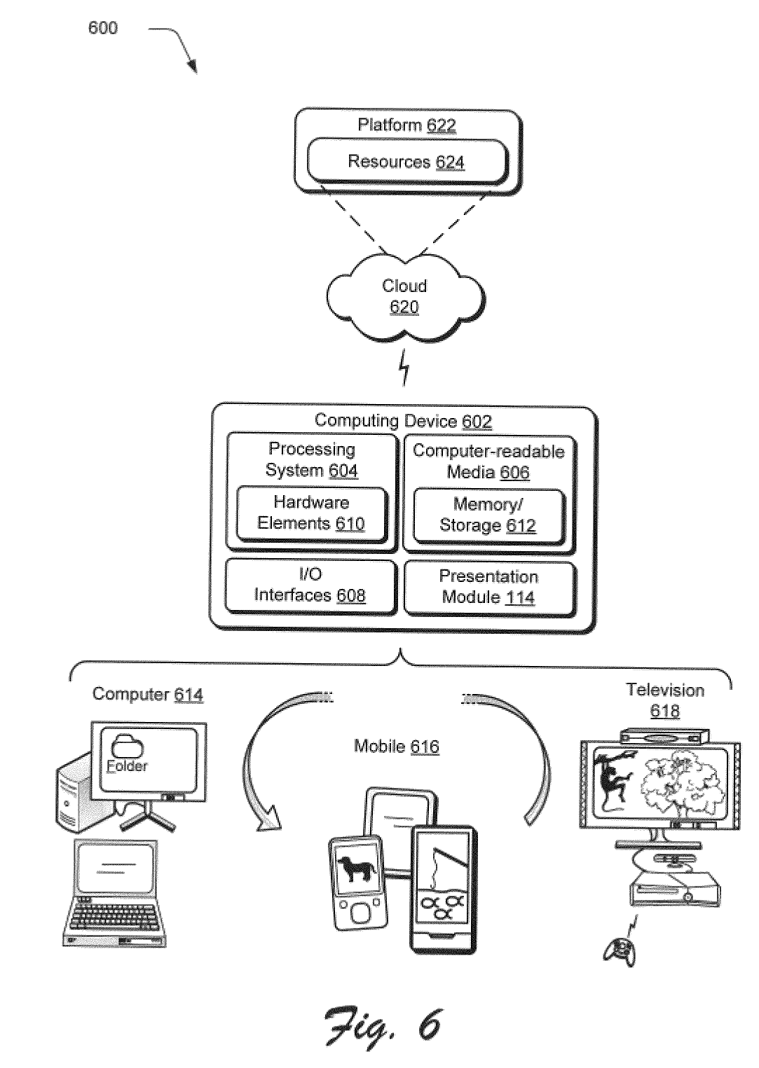

FIG. 1 is an illustration of an environment 100 in an example implementation that is operable to employ presentation techniques described herein. The illustrated environment 100 includes an example of a computing device 102 that may be configured in a variety of ways, the illustrated example of which is a mobile communications device such as a mobile phone or tablet computer. The computing device 102, for example, may be configured as a traditional computer (e.g., a desktop personal computer, laptop computer, and so on), a mobile station, an entertainment appliance, a game console communicatively coupled to a display device (e.g., a television) as illustrated, a netbook, and so forth as further described in relation to FIG. 6. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 may also relate to software that causes the computing device 102 to perform one or more operations.

The computing device 102 is illustrated as including an input/output module 104. The input/output module 104 is representative of functionality relating to recognition of inputs and/or provision of outputs by the computing device 102. For example, the input/output module 104 may be configured to receive inputs from a keyboard, mouse, to identify gestures and cause operations to be performed that correspond to the gestures, and so on. The inputs may be detected by the input/output module 104 in a variety of different ways.

The input/output module 104 may be configured to receive one or more inputs via touch interaction with a hardware device, such as a controller 106 as illustrated. The controller 106 may be configured as a separate device that is communicatively coupled to the computing device 102 or as part of the computing device 102, itself. Accordingly, touch interaction may involve pressing a button, moving a joystick, movement across a track pad, use of a touch screen of a display device 108 of the computing device 102 (e.g., detection of a finger of a user's hand or a stylus), detection of movement of the computing device 102 as a whole (e.g., using one or more accelerometers, cameras, IMUs, and so on to detect movement in three dimensions), and so on.

Recognition of the touch inputs may be leveraged by the input/output module 104 to interact with a user interface output by the computing device 102, such as to interact with a presentation output by the computing device 102, an example of which is displayed on the display device 108 as a slide of a presentation that includes text “Winning Football” as well as another object, which is a football in this example. A variety of other hardware devices are also contemplated that involve touch interaction with the device. Examples of such hardware devices include a cursor control device (e.g., a mouse), a remote control (e.g. a television remote control), a mobile communication device (e.g., a wireless phone configured to control one or more operations of the computing device 102), and other devices that involve touch on the part of a user or object.

The input/output module 104 may also be configured to provide an interface that may recognize interactions that may not involve touch through use of an input device 110. Although the input device 110 is displayed as integral to the computing device 102, a variety of other examples are also contemplated, such as through implementation as a stand-alone device as previously described for the controller 106.

The input device 110 may be configured in a variety of ways to detect inputs without having a user touch a particular device, such as to recognize audio inputs through use of a microphone. For instance, the input/output module 104 may be configured to perform voice recognition to recognize particular utterances (e.g., a spoken command) as well as to recognize a particular user that provided the utterances.

In another example, the input device 110 may be configured to recognize gestures, presented objects, images, and so on through use of one or more cameras. The cameras, for instance, may be configured to include multiple lenses and sensors so that different perspectives may be captured and thus determine depth. The different perspectives, for instance, may be used to determine a relative distance from the input device 110 and thus a change in the relative distance between the object and the computing device 102 along a “z” axis in an x, y, z coordinate system as well as “side to side” and “up and down” movement along the x and y axes. Thus, the different perspectives may be leveraged by the computing device 102 as depth perception.

The images may also be leveraged by the input/output module 104 to provide a variety of other functionality, such as techniques to identify particular users (e.g., through facial recognition), objects, movement, and so on. Although illustrated as facing toward a user in the example environment, the input device 110 may be positioned in a variety of ways, such as to capture images and voice of a plurality of users, e.g., an audience viewing the presentation.

The input-output module 106 may leverage the input device 110 to perform skeletal mapping along with feature extraction of particular points of a human body (e.g., 48 skeletal points) to track one or more users (e.g., four users simultaneously) to perform motion analysis that may be used as a basis to identify one or more gestures. For instance, the input device 110 may capture images that are analyzed by the input/output module 104 to recognize one or more motions made by a user, including what body part is used to make the motion as well as which user made the motion. An example is illustrated through recognition of positioning and movement of one or more fingers of a user's hand 112 and/or movement of the user's hand 112 as a whole. The motions may be identified as gestures by the input/output module 104 to initiate a corresponding operation of the computing device 102.

A variety of different types of gestures may be recognized, such a gestures that are recognized from a single type of input (e.g., a motion gesture) as well as gestures involving multiple types of inputs, e.g., a motion gesture and a press of a button displayed by the computing device 102, use of the controller 106, and so forth. Thus, the input/output module 104 may support a variety of different gesture techniques by recognizing and leveraging a division between inputs. It should be noted that by differentiating between inputs in the natural user interface (NUI), the number of gestures that are made possible by each of these inputs alone is also increased. For example, although the movements may be the same, different gestures (or different parameters to analogous commands) may be indicated using different types of inputs. Thus, the input/output module 104 may provide a natural user interface that supports a variety of user interaction's that do not involve touch.

Accordingly, although the following discussion may describe specific examples of inputs, in instances different types of inputs may also be used without departing from the spirit and scope thereof. Further, although in instances in the following discussion the gestures are illustrated as being detected using the input device 110, touchscreen functionality of the display device 108, and so on, the gestures may be input using a variety of different techniques by a variety of different devices.

The computing device 102 is further illustrated as including a presentation module 114. The presentation module 114 is representative of functionality of the computing device 102 to create and/or output a presentation 116 having a plurality of slides 118. In the illustrated example, the computing device 102 is communicatively coupled to a projection device 102 via a network 122, such as a wireless or wired network. The projection device 120 is configured to display 124 slides 118 of the presentation 116 in a physical environment 126 to be viewable by an audience of one or more other users and a presenter of the presentation 116.

The projector 120 is representative of functionality to display 124 the presentation 116 in a variety of different ways. The projector 120, for instance, may be configured to output the display 124 to support two dimensional and even three dimensional viewing in the physical environment. The projector 120, for instance, may be configured to project the display 124 against a surface of the physical environment 126 and/or out into the physical environment 126 such that display 124 appears to “hover” without support of a surface, e.g., holographic display, perspective 3D projections, and so on. Again, although a projector 120 is shown in the illustrated example, the computing device 102 may employ a wide variety of different types of display devices to display 124 the presentation 116.

In one or more implementation, the presentation module 114 may be configured to compute a 3D model of the physical environment 126, e.g., using one or more Input devices 110. The presentation module 114 may then support functionality to move a view point. This may include use of a linear or two dimensional array of physical cameras that allow the presentation module 114 to synthesize in real-time the view points between the cameras, which may provide a synthesized view as a function of a user's gaze.

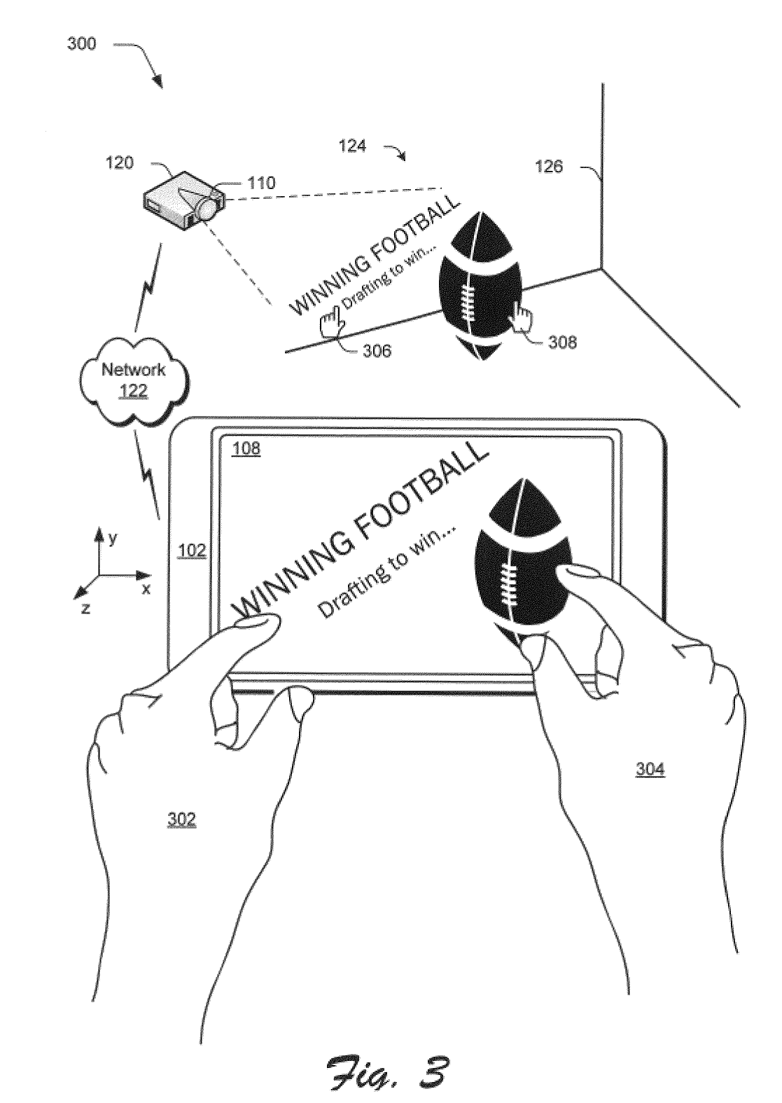

The presentation module 114 is further illustrated as including a 3D object module 128. The 3D object module 128 is representative of functionality to include a 3D object 130 in a slide 118 of a presentation 116. Examples of the 3D object 130 are illustrated in FIG. 1 as a football and text, e.g., “Winning Football” and “Drafting to win . . . ” as being displayed 124 by the projector 120 in the physical environment 126. In one or more implementations, the 3D object 130 may be configured to be manipulable during the display 124 of the presentation 116, such as through resizing, rotating, movement, and so on, further discussion of which may be found in relation to FIG. 3.

Generally, any of the functions described herein can be implemented using software, firmware, hardware (e.g., fixed logic circuitry), or a combination of these implementations as further described in relation to FIG. 6. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

FIG. 2 is an illustration of a system 200 in an example implementation showing creation of an animation for inclusion in a presentation using one or more gestures. The computing device 102 is illustrated as a desktop computer, although other configurations are also contemplated as previously described.

The presentation module 114 of the computing device 102 in this example is utilized to output a user interface via which a user may interact to compose the presentation 116. The presentation module 114, for instance, may include functionality to enable a user to supply text and other objects to be included in slides 118 of the presentation 116. These objects may include 3D objects 130 through interaction with the 3D object module 128, such as the football 202 illustrated on the display device 108.

As part of the functionality to create the presentation 116, the presentation module 114 may also support techniques in which a user may configure an animation through one or more gestures. The presentation module 114, for instance, may include an option via which a user may “begin recording” of an animation, an example of which is shown as a record button 204 that is selectable via the user interface displayed by the display device 108, although other examples are also contemplated. The user may then interact with the user interface through one or more gestures, and have a result of those gestures recorded as an animation.

In the illustrated example, a user has selected the football 202 and moved the football 202 along a path 206 that is illustrated through use of a dashed line. This movement may be used to configure an animation that follows this movement for output as part of the slide 118 of the presentation 116. The movement, for instance, may be repeated at a rate at which the movement was specified, at a predefined rate, and so on. In this way, a user may interact with the presentation module 114 in an intuitive manner to create the presentation 116.

Although movement of an object using a gesture was described, a variety of different gestures and interaction may be supported. Examples of such gestures includes gestures to resize an object, rotate an object, change a perspective of an object, change display characteristics of an object (e.g., color, outlining, highlighting, underlining), and so forth. Additionally, as previously described the gestures may be detected in a variety of ways, such as through touch functionality (e.g., a touchscreen or track pad), a input device 110, and so forth.

The presentation module 114 may also expose functionality to embed 3D information within the presentation 116. This may be done in a variety of ways. For example, a graphics format may be used to store objects and support interaction with the objects, such as through definition of an object class. An API may also be defined to support individual gestures as further described in relation to FIG. 3.

FIG. 3 depicts a system 300 in an example implementation showing display and manipulation of a 3D object included in a presentation. In this example, the presentation 116 is illustrated as displayed by a projector 120 and includes a three-dimensional object illustrated as a football and text as previously described. As should be apparent, a projected presentation does not have an active physical display as is the case when displayed on a physical surface, such as on the display device 108 of the computing device 102. Accordingly, a variety of other techniques may be employed to support interaction with the display 124.

The presentation 116, for instance, may be illustrated on a display device 108 that may or may not include touch functionality to detect gestures, e.g., made by using one or more hands 302, 304 of a user as illustrated. In the illustrated embodiment, the presentation 116 is also displayed on the display device 108 and thus may support gestures to interact with the presentation as displayed 124 by the projector 120. Thus, a user may interact via gestures with a user interface output by the display device 108 of the computing device 102 to control the presentation 116, such as to navigate through the presentation 116, manipulate a three-dimensional object in the presentation, and so on.

Other controllers 106 separate from the computing device 102 may also be used to support interaction with the presentation 116. One example of such a controller 106 may include a input device 110 as previously described (e.g., a depth camera, stereoscopic, structured light device, and so on) that is configured for interaction with users in the physical environment 126, such as by a presenter as well as members of an audience viewing the presentation.

The input device 110 may be used observe users in range of the display and sense non-touch gestures made by the users to control the presentation, interact with 3D objects, control output of embedded video, and so forth. Examples of such gestures include gestures to select a next slide, navigate backward through the slides, “zoom in” or “zoom out” the display 124, and so on. The input device 110 may also support voice commands, which in some examples may be used in conjunction with physical gestures to control output of the presentation 116.

The presentation 116 may be configured to leverage gesture data to indicate which gestures and other motions are performed by a presenter to interact with the display 124 of the presentation. An example of this is illustrated through a display of first and second hands 306, 308 in the display 124 of the presentation that correspond to the hands 302, 204 of the user detected by the computing device 102 as part of the gesture. In this way, the display of the first and second hands 306, 308 may aide interaction on the part of the presenter when using a input device 110 as well as provide a guide to an audience viewing the presentation. Although hands 306, 308 are illustrated, a variety of other examples are also contemplated, such as through use of shading and so forth.

In another example, the computing device 102 and/or another computing device in communication with the computing device (e.g., a mobile phone or tablet in communication with a laptop used to output the presentation 116) may act as the controller 106. The computing device 102, for instance, may be configured as a mobile phone that can detect an input as involving one or more of x, y, and/or z axes. This may include movement of the computing device 102 as a whole (e.g., toward or away from a user holding the device, tilting, rotation, and so on), use of sensors to detect pressure (e.g., which may be used to control movement along the z axis), use of hover sensors, and so forth. This may be used to support a variety of different gestures, such as to specify interactions with particular objects in a slide, navigation between slides, and so forth.

Further, the movement of the computing device 102 as a whole may be combined with gestures detected using touch functionality (e.g., a touchscreen of the display device 108) to guide spatial transition, manipulation of objects, and so on. This may be used as an aid for disambiguation and support rich gesture definitions.

A variety of such gestures are contemplated for interaction with an output of the computing device 102. For example, a mobile device may act as a controller 106 and held by a first hand of a user. Another hand of the user may be moved toward or away from the computing device 102 to indicate a zoom amount, distance for movement, and so on. Thus, movement may be mapped along the axis perpendicular to the planar orientation of the mobile device's display device 108.

In another example, rotational interaction may be supported by holding the mobile device and and swiveling both hands to suggest motion of the object (e.g., a three dimensional object included in the display 124) about a turntable. Such rotation movements may apply a gain factor or nonlinear acceleration function to the inputs to articular a full 360 degree motion with limited movement of the computing device 102 or other controller 106.

In a further example, tilting or tipping interactions may be supported by first holding the mobile device and then tipping the device, by making this motion in conjunction with tipping the off-hand in a seesawing motion (in combination with motion of handheld device), and so on.

In yet another example, the mobile device may be held and pointed at the display 124 to move an object (e.g. photo, a slide) from the display device 108 of the mobile device for display 124 by the projector 120. This may be used to support nonlinear output of the slides of the presentation 116.

In an example, a first hand of a user may be pointed at the display 124 and the other hand of the user may be used to move the computing device 102 toward the user to indicate grabbing of an object from the display 124 of the projector 120 to the display device 108 of the computing device 102. In another example, a finger of the user's hand may be held against the display device 108 and the other hand of the user may make a flipping motion to the left or right to navigate in a corresponding direction through the slides.

In a further example, the display device 108 may be held and another hand of the user may be oriented “palm up” to indicate a pause in the presentation 116, to pause a display of video. The hand may be waved to resume output.

In yet another example, the display device 108 may be held and a gesture may be made toward or away from the display 124 of the projector 120 to indicate movement between semantic levels of detail in the presentation. This may include navigation through sections/subsections of a presentation.

Thus, these gestures include examples of co-articulated gestures where contact and motion of a handheld device (e.g., controller 106 or the computing device 102 itself) may be interpreted in conjunction with spatial sensors, e.g., a input device 110 included as part of the protector 120 or elsewhere in the physical environment 126. As described above, the user may hold the display device 108 of a handheld device, and orient the device, while pulling the opposite hand away from the screen to indicate a degree of zooming. Here, the touch signal indicates that the computing device 102 is to “listen” to the spatial motions detected by the input device 110. The orientation of the display device 108 may further indicate a user-centric coordinate system for articulation of z-axis motion. The motion of the opposite hand towards or away from the device indicates the amount of zooming, as indicated by the distance sensed between the hands (again using the spatial sensing, or possibly proximity sensor(s) on the mobile device itself).

The co-articulation of spatial gestures across a handheld device and a projected display 124 may be used ameliorate many of the problems conventionally associated with freehand gestures, such as ambiguity of intent, e.g., is the user gesturing to the system, or to the audience. This may also be used by the computing device 102 to remove ungainly time-outs or uncomfortable static poses in favor of rapid, predictable, and consistent motions made possible by employing the handheld to help cue in-air gesture tracking (for direct manipulations) and gesture recognition (i.e. for recognition gestures after the user finishes articulating them, rather than real-time direct manipulation while the user moves).

Thus, by supporting rich interaction with the display 124 of the presentation 116, the presentation 116 may support the creation of a nonlinear story involving the objects in the slide of the presentation 116 instead of being limited to a strict linear order as was encountered using conventional techniques.

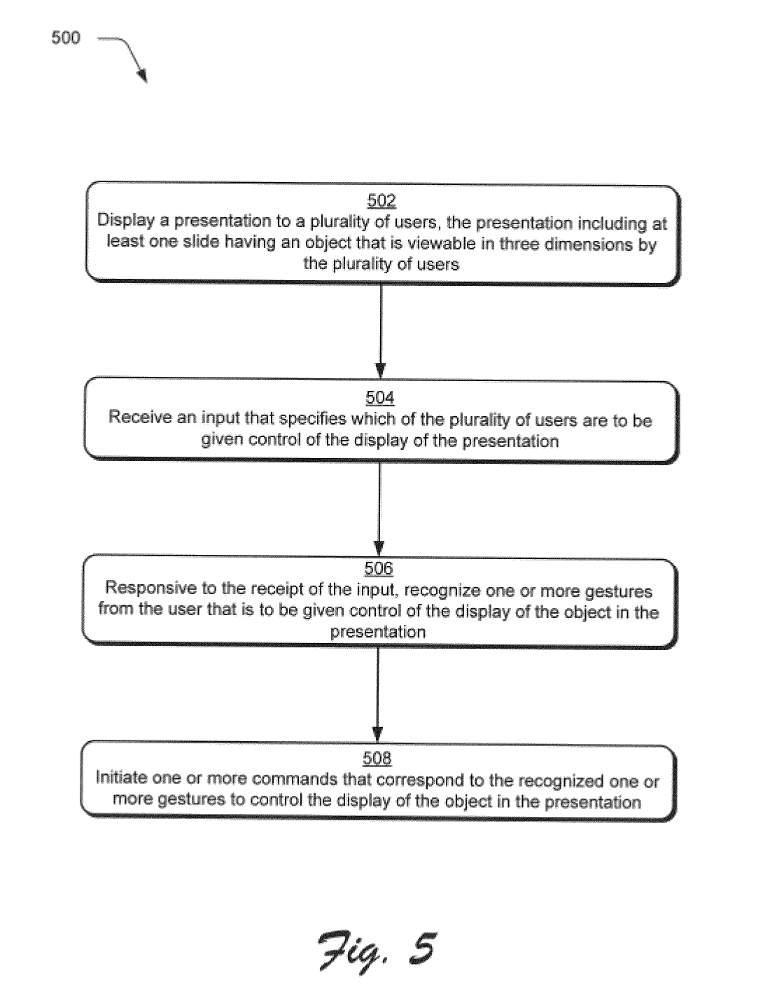

The presentation module 114 may also support functionality to pass control of the presentation, such as from a presenter to one or more members of an audience. For example, the presentation module 114 may support gestures to indicate a particular user that is to be given control of the presentation, e.g., by a presenter and/or a user that is to receive control. The presentation may then be “handed” to that user for interaction. Thus, interactivity of the presentation 116 may be increased, further discussion of which may be found in relation to FIG. 5.

Example Procedures

The following discussion describes presentation techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the systems 200, 300 of FIGS. 2 and 3, respectively.

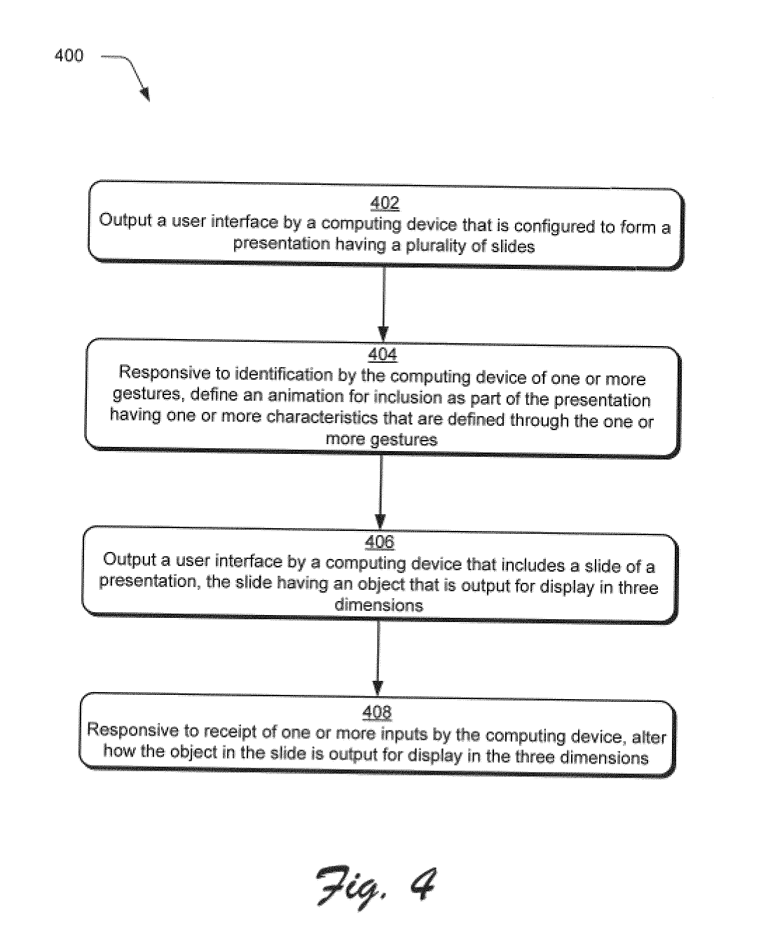

FIG. 4 depicts a procedure 400 in an example implementation in which a user interface is created and output. A user interface is output by a computing device that is configured to form a presentation having a plurality of slides (block 402). The presentation module 114, for instance, may output a user interface that is usable by a user to create the presentation 116 and slides 118 within the presentation 116, including inclusion of objects such as text, embedded video, three dimensional objects, and so on.

Responsive to identification by the computing device of one or more gestures, an animation is defined for inclusion as part of the presentation having one or more characteristics that are defined through the one or more gestures (block 404). The gestures, for instance, may be used to move, resize, change display characteristics, rotate, as well as perform other actions on objects included in the presentation 116. The user may thus provide gestures that are used to define an animation for inclusion in the presentation.

A user interface is then output by the computing device that includes a slide of a presentation, the slide having an object that is output for display in three dimensions (block 406). The slide 118, for instance, may include a 3D object 130 for display, such as display 124 by a projector 120 in a physical environment 126 or other display device.

Responsive to receipt of one or more inputs by the computing device, an alteration is made as to how the object in the slide is output for display in the three dimensions (block 408). The presentation module 114, for instance, may support gestures to interact with the 3D object 130, such as to move, resize, change display characteristics (color, shadow), rotate, and so forth. Thus, the 3D object 130 may support rich interactions that may promote nonlinear output of the presentation 116 as described above.

FIG. 5 depicts a procedure 500 in an example implementation in which control of a presentation is passed between users. A presentation is displayed to a plurality of users, the presentation including at least one slide having an object that is viewable in three dimensions by the plurality of users (block 502). The presentation 116, for instance, may include a slide 118 having a 3D object 130 that is displayed 124 by a projector 120 into a physical environment.

An input is received that specifies which of the plurality of users are to be given control of the display of the presentation (block 504). The input, for instance, may originate from a presenter (e.g., a person that has control of the presentation) and indicate a particular user to which the control is to be passed. In another example, the particular user may provide the input. A variety of inputs are contemplated, such as gestures detected using a input device 110, detected using respective controllers 106 (e.g., mobile devices) held by the users, and so forth.

Responsive to the receipt of the input, one or more gestures are recognized from the user that is to be given control of the display of the presentation (block 506). One or more commands are then initiated that correspond to the recognized one or more gestures to control the display of the object in the presentation (block 508). The gestures, for instance, may be used to navigate through the slides 118 of the presentation 116, navigate through objects within the slides 118, and so forth. Thus, a variety of different users may interaction with the presentation 116 as previously described through designate of which of the controllers are to be designated as a primary controller, which may be passed between users and/or devices of the users.

Example System and Device

FIG. 6 illustrates an example system generally at 600 that includes an example computing device 602 that is representative of one or more computing systems and/or devices that may implement the various techniques described herein. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interface 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 606 is illustrated as including memory/storage 612. The memory/storage 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

As further illustrated in FIG. 6, the example system 600 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on. This is illustrated through inclusion of the presentation module 114 on the computing device 602, the functionality of which may also be described over the cloud 620 as part of a platform 622 as described below.

In the example system 600, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 602 may assume a variety of different configurations, such as for computer 614, mobile 616, and television 618 uses. Each of these configurations includes devices that may have generally different constructs and capabilities, and thus the computing device 602 may be configured according to one or more of the different device classes. For instance, the computing device 602 may be implemented as the computer 614 class of a device that includes a personal computer, desktop computer, a multi-screen computer, laptop computer, netbook, and so on.

The computing device 602 may also be implemented as the mobile 616 class of device that includes mobile devices, such as a mobile phone, portable music player, portable gaming device, a tablet computer, a multi-screen computer, and so on. The computing device 602 may also be implemented as the television 618 class of device that includes devices having or connected to generally larger screens in casual viewing environments. These devices include televisions, set-top boxes, gaming consoles, and so on.

The techniques described herein may be supported by these various configurations of the computing device 602 and are not limited to the specific examples of the techniques described herein. This functionality may also be implemented all or in part through use of a distributed system, such as over a “cloud” 620 via a platform 622 as described below.

The cloud 620 includes and/or is representative of a platform 622 for resources 624. The platform 622 abstracts underlying functionality of hardware (e.g., servers) and software resources of the cloud 620. The resources 624 may include applications and/or data that can be utilized while computer processing is executed on servers that are remote from the computing device 602. Resources 624 can also include services provided over the Internet and/or through a subscriber network, such as a cellular or Wi-Fi network.

The platform 622 may abstract resources and functions to connect the computing device 602 with other computing devices. The platform 622 may also serve to abstract scaling of resources to provide a corresponding level of scale to encountered demand for the resources 624 that are implemented via the platform 622. Accordingly, in an interconnected device embodiment, implementation of functionality described herein may be distributed throughout the system 600. For example, the functionality may be implemented in part on the computing device 602 as well as via the platform 622 that abstracts the functionality of the cloud 620.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
outputting a user interface by a computing device that includes a slide of a presentation, the slide having an object that is configured for output in three dimensions; and
responsive to receipt of one or more inputs by the computing device, altering how the object in the slide is output for display in the three dimensions.

2. A method as described in claim 1, wherein the object is output for display as a three-dimensional object in the three dimensions or output for display as a two-dimensional perspective of the three dimensions.

3. A method as described in claim 1, wherein the one or more inputs are received by the computing device from a controller that supports user interaction.

4. A method as described in claim 3, wherein the altering includes display of one or more indications in the user interface as part of the presentation, the one or more indications describing which gestures were identified from the one or more inputs to perform the altering.

5. A method as described in claim 3, wherein the controller is configured as a mobile communications device having a touchscreen and one or more sensors configured to detect movement in three dimensions, the one or more inputs provided by the one or more sensors that describe movement in the three dimensions.

6. A method as described in claim 5, wherein the one or more sensors are configured to detect movement in at least one of the three dimensions using pressure.

7. A method as described in claim 3, wherein the controller leverages one or more cameras such that a user is permitted to initiate the one or more inputs without touching the controller.

8. A method as described in claim 1, wherein the one or more inputs include voice commands.

9. A method as described in claim 1, further comprising resolving which of a plurality of controllers that are communicatively coupled to the computing device are permitted to alter how the object is displayed, each of the controllers communicatively coupled to the computing device to provide the one or more inputs and operable by a respective one of a plurality of users that view the output of the presentation.

10. A method as described in claim 9, wherein the resolving is based on which of the plurality of controllers has been indicated as a primary controller, this indication being passable by the user of the controller that is associated with the indication to another said user associated with another said controller.

11. A method as described in claim 1, wherein the one or more inputs are received from a sensor including one or more cameras that are used to detect motions made by a plurality of users that view the presentation and further comprising resolving which of a plurality of users are permitted to alter how the object is displayed based on identification of a gesture made by one of the users that indicates that the user is to be given control of the presentation.

12. A method as described in claim 1, wherein the presentation includes a plurality of slides, at least one of which is the slide having the object, the plurality of slides navigable in the user interface in a non-linear order as specified by a user.

13. A method comprising:
outputting a user interface by a computing device that is configured to form a presentation having a plurality of slides; and
responsive to identification by the computing device of one or more gestures, defining an animation for inclusion as part of the presentation having one or more characteristics that are defined through the one or more gestures.

14. A method as described in claim 13, wherein the one or more gestures describe movement of an object as part of a display of a corresponding said slide using the animation.

15. A method as described in claim 13, wherein the one or more gestures initiate a transition from display of one said slide to display of another said slide using the animation.

16. A method as described in claim 13, wherein the one or more gestures initiate resizing of an object as part of a display of a corresponding said slide using the animation.

17. A method implemented by one or more computing devices, the method comprising:
displaying a presentation to a plurality of users, the presentation including at least one slide having an object that is viewable in three dimensions by the plurality of users;
receiving an input that specifies which of the plurality of users are to be given control of the display of the presentation;
responsive to the receiving of the input, recognizing one or more gestures from the user that is to be given control of the display of the object in the presentation; and
initiating one or more commands that correspond to the recognized one or more gestures to control the display of the object in the presentation.

18. A method as described in claim 17, wherein the recognizing of the one or more gestures is performed by analyzing one or more images taken by one or more cameras.

19. A method as described in claim 17, wherein the input that specified which of the plurality of users are to be given control of the display of the presentation is not detected by the one or more cameras.

20. A method as described in claim 17, wherein the recognizing of the one or more gestures includes identification of a motion made by a user along a z axis defined between the user and the display of the presentation.
